(19) United States
(12) Patent Application Publication
(10) Pub. No.: US 2021/0357984 A1
(43) Pub. Date: Nov. 18, 2021

(54) METHOD OF PROVIDING TARGETED ADVERTISEMENT BASED ON REAL-TIME VIDEO ANALYSIS AND APPARATUS THEREFOR

(71) Applicant: ELUMICATE INC., Moncton (CA)

(72) Inventors: Olivier BERTRAND, Moncton (CA); Ted GUENICHE, Moncton (CA)

(73) Assignee: ELUMICATE INC., Moncton (CA)

(21) Appl. No.: 17/320,806

(22) Filed: May 14, 2021

(30) Foreign Application Priority Data
May 15, 2020 (CA) 3080685

(51) Int. Cl. G06Q 30/02

(52) U.S. Cl. CPC G06Q 30/0269

(57) ABSTRACT

The present disclosure provides for an apparatus to connect to a display device such as a billboard. The apparatus is comprised of a camera to record live traffic and a processor and circuits to analyze the live traffic and generate classified data from the recorded traffic. The classified data may include characteristics such as vehicle type, person traits, the weather, etc. This classified data is then used by an operator, who may wish to target specific persons within the live traffic stream with a specific advertisement geared to those specific persons. The present disclosure also provides for a method of generating a targeted advertisement based on chosen characteristics of the classified data set.

### CROSS REFERENCE TO RELATED APPLICATION

The present application claims priority to Canadian Application No. 3,080,685, entitled “METHOD OF PROVIDING TARGETED ADVERTISEMENT BASED ON REAL-TIME VIDEO ANALYSIS AND APPARATUS THEREFOR” filed on May 15, 2020, the contents of which are incorporated herein by reference in their entirety.

### FIELD

The disclosure relates to the field of advertisement, and more specifically to a method of providing targeted advertisements based on real-time video analysis and an apparatus therefor.

### BACKGROUND

During the early 20th century, the growing use of automobiles quickly led to companies making use of billboard advertising to publicize a wide range of products and services. Motor villages and motels would buy or lease billboards as a means of directing potential customers to their facilities. Towns and cities made use of billboard advertising to entice the traveler to stop long enough to see some of the local sights before moving on with the journey. Roadside restaurants made use of billboards to advertise hot meals for competitive prices. The effectiveness of these advertisements led to creating an entirely new branch of the advertising industry as clients demanded newer and more attractive advertisements that would catch the eye and entice the traveler to stop and spend money.

In the early 1900s, there was a boom in national billboard campaigns. Big advertisers began mass production of billboards for the national market. From toothpaste and soaps, to breakfast cereals and sodas, billboards were made to advertise in big, bold pictures and images. In 1913, the practice of filling “open boards” with public service advertising began and has continued to this day. During the war there was a concerted effort from the industry to help in the mobilization while in peacetime the concern was focused on efforts to generally improve the way of life.

With the advent of digital technology, hand-painted boards were replaced by computer-painted outdoor advertising formats. Outdoor companies offered a diverse range of advertising formats including bus shelters, transit and kiosks, airport advertising, mall displays, and taxis.

A digital billboard is a billboard that shows varying imagery and text created from computer programs and software. Digital billboards can be designed to display running text, display several different displays from the same company, and even provide several companies in a certain time slot during the day. The constantly changing texts ensure maximum impact and wide exposure to target audiences. The ability to schedule advertisements remotely, in combination with flexible real-time scheduling, has allowed for a decrease in traditional upkeep and maintenance costs.

### SUMMARY

In an aspect, the present disclosure provides an apparatus mechanically and electrically secured to a display device to provide targeted advertisements based on real-time video analysis comprising: a camera unit to record a live video feed; a processor to process the live video feed and generate a classified data set; a communication device to transmit the classified data set; and, at least two circuits electrically connected to the processor and the communication device, wherein the apparatus is adapted to communicate with remote data centers, and wherein the communication device sends the classified data set to the display device to display the targeted advertisements.

In another aspect, the present disclosure provides a method of providing targeted advertisements based on real-time video analysis, the steps comprising: receiving a live video feed; processing the live video feed to generate a classified data set; and, sending an instruction based on the classified data set to a display device to display the targeted advertisement.

In yet another aspect, the present disclosure provides a method of generating targeted advertisements based on chosen characteristics, the steps comprising: creating a potential persona based on the chosen characteristics; comparing the potential persona with a database to find a match; creating a target persona based on the match; and, sending an instruction to a display device, the instruction containing the target persona, wherein the instruction instructs the display device to display the targeted advertisements.

### BRIEF DESCRIPTION OF THE DRAWINGS

The following figures serve to illustrate various embodiments of features of the disclosure. These figures are illustrative and are not intended to be limiting.

FIG. 1 is a block diagram of a capturing apparatus to provide targeted advertisements based on real-time video analysis connected to a billboard and the cloud, according to an embodiment of the present disclosure;

FIG. 2 is a block diagram of a capturing apparatus of the system of FIG. 1 according to an embodiment of the present disclosure;

FIG. 3 is a block diagram of a method for analyzing a live video feed of the system of FIG. 1 according to an embodiment of the present disclosure;

FIG. 4 is a block diagram of a method for displaying a targeted advertisement of the system of FIG. 1 according to an embodiment of the present disclosure;

FIG. 5 is a block diagram of a method of displaying a targeted advertisement based on chosen characteristics of a target persona, according to an embodiment of the present disclosure;

FIG. 6 is a block diagram of a method for creating a target persona of the method of FIG. 5 and according to an embodiment of the present disclosure;

FIG. 7 is a block diagram of a method for displaying a targeted advertisement based on the target persona of the method of FIG. 5 and according to an embodiment of the present disclosure;

FIG. 8A is a screenshot of a graphical user interface of the system of FIG. 1 according to an embodiment of the present disclosure; and,

FIG. 8B is another screenshot of the graphical user interface of the system of FIG. 1 according to an embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

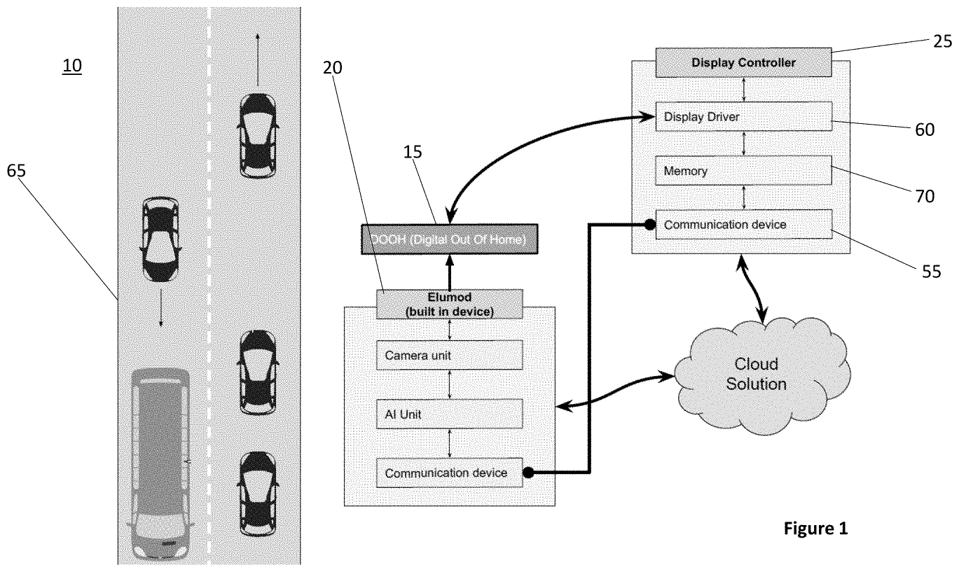

With reference to FIG. 1 and according to an embodiment of the present disclosure, a system 10 to provide targeted advertisements based on real-time video analysis 10 is shown. In this particular embodiment, the targeted advertisements are displayed on a billboard 15; however, other suitable display devices may be used without departing from the scope of the disclosure. The system 10 is preferably comprised of a capturing apparatus 20 to capture, record and analyze the live video feed. The system 10 is also comprised of a display controller 25 to receive information, which may be in the form of a data set and send instructions to the billboard 15 based on the information.

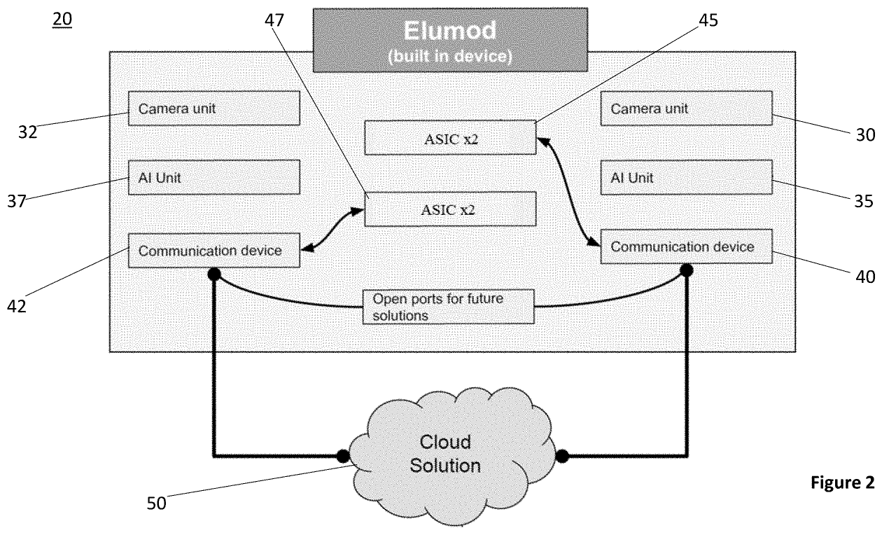

With reference to FIGS. 1 and 2 and according to an embodiment of the present disclosure, the capturing apparatus is further comprised of a camera 30 connected to an artificial intelligence (AI) processor 35. The AI processor 35 is in turn connected to a communication device 40, which is connected to two Application-Specific Integrated Circuits (ASICs) 45. A worker skilled in the art would appreciate that the capturing apparatus 20 only requires a single camera 30, AI processor 35, communication device 40 and two ASICs 45 to operate. However, in an alternate embodiment as shown in FIG. 2, the apparatus 20 is comprised of redundant elements ideally used for testing purposes or to provide enhanced image processing. Indeed, FIG. 2 describes two cameras 30, 32, each of the cameras 30, 32 connected to its own artificial intelligence (AI) processor 35, 37. The two AI processors 35, 37 are each connected to two communication devices 40, 42. A worker skilled in the art would appreciate that in a preferred embodiment the communication devices 40, 42 may be Raspberry Pi™, although other similar devices, such as many single-board computers, may be used. The first communication device is connected to two ASICs 45, whereas the second communication device 42 is connected to two ASICs 47. The communication devices 40, 42 are also adapted to wirelessly connect to remote data centers and servers, more commonly referred to in the art as the cloud 50. The communications devices 40, 42 may also adapted to communicate with a controller communication device 55 of the display controller 25. Indeed, a worker skilled in the art would appreciate that some billboards 15 have a built-in means for connecting to the Internet, such as a built-in network card taking the form of communication device 55. However, in another embodiment, the billboard 15 may not have any means to connect to the Internet. In this instance, the communication device 40 would be wired directly into the billboard 15 by means of cabling known in the art, such as RJ45 ethernet cables. The controller communication device 55 engages a display driver 60 of the display controller 25, which can then send instructions to the billboard 15 to display a targeted advertisement. Preferably during operation of the system 10, the camera 30 records a live video feed of the road ahead 65, including vehicles, pedestrians, drivers, etc. The live video feed is cropped and analyzed by the AI processor 35, which classifies the isolated content received from the video feed. The AI processor 35 works with the two ASICs 45 to treat the video and classify objects into several predetermined categories. Such categories may include the vehicle's brand, make, model or colour, the pedestrian or driver's gender or age, and include other information such as the frequency of the vehicle or pedestrian driving by or the time of day. This classified data is then sent to the cloud 50 for storage and further analysis. The classified data may also be sent to the controller communication device 55 of the display controller 25 of the billboard 15, depending on whether the billboard 15 is comprised of such a communication device 55. Using cloud computing services, the classified data is analyzed and stored, and can be utilized by users of the system 10 to provide targeted advertisements based on a chosen targeted person, which is referred to as the “target persona”. Target personas are described in greater detail below. Based on the target persona selected, an instruction is then sent to the display driver 60. The display driver 60 is in communication with both a memory unit 70 of the billboard 15 and the billboard 15 itself to display a targeted advertisement (ad) based on the classified data. By way of example, the camera 30 may record a live video feed that includes a multitude of cars. The plurality of cars is then processed by the AI processor 35 and the two ASICs 45, which identify and classify the data as including a vehicle from a particular car manufacturer. This identification and classification are based on an internal library of vehicles. This particular car manufacturer information is part of the information package transmitted to the cloud 50. If the particular car manufacturer forms part of the desired characteristics of a target persona as chosen by an operator of the system 10, an instruction is sent to the communication device 55 of the display controller 25. The controller communication device 55 forwards the instruction to the display driver 60, which then pulls a targeted advertisement based on the earlier identified particular car manufacturer from the memory unit 70 and displays the targeted advertisement on the billboard 15. This entire process of: processing the live video feed; identifying a predetermined characteristic; transmitting an instruction based on the predetermined characteristic to the display controller 25; and, displaying a targeted ad based on the instruction, takes approximately 2 seconds. As such, a vehicle or person approaching the billboard 15 is recognized based on certain parameters, and a targeted advertisement is displayed before the vehicle or person passes by the billboard 15.

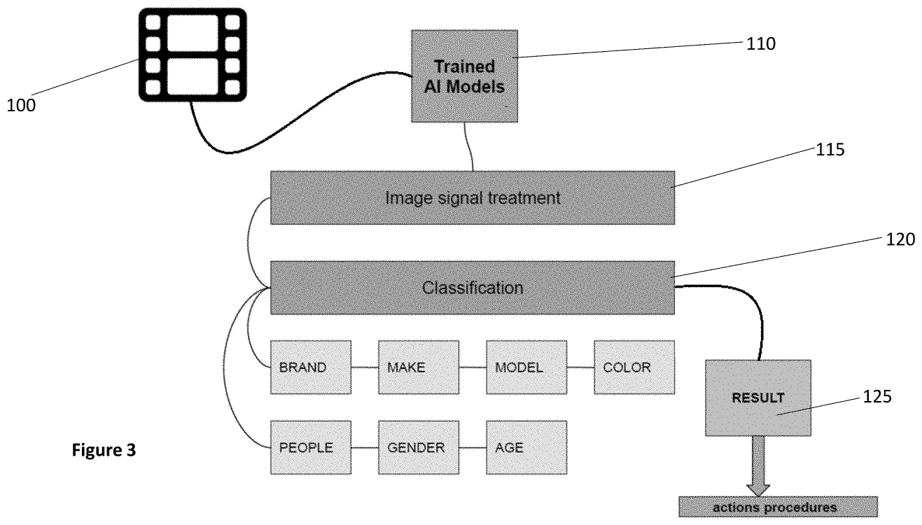

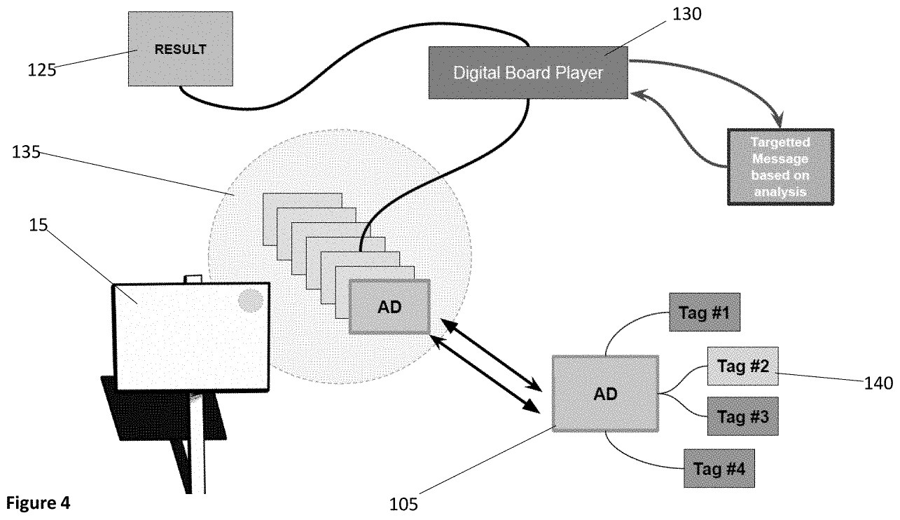

With reference to FIGS. 3 and 4 and according to an embodiment of the present disclosure, a method for analyzing a live video feed 100 and displaying a targeted advertisement 105 is shown. The present system is comprised of trained AI models 110 that run on the ASICs (not shown). Such AI models 110 process the image 115 and classify the image 120. The classification step 120 is further comprised of two sub-steps: a feature extraction sub-step, whereby features are extracted to determine, for example, a vehicle's brand, made, model colour, year, a pedestrian's sex, age, etc.; and, a classification sub-step, whereby the aforementioned features are classified to ease the pattern calculation and creation and for the system to compute the proper information. Once the video feed 100 has been classified, the result 125 is transmitted to the digital board player 130 of the billboard 15. A worker skilled in the art would be familiar with the digital board player 130, which is a platform used by billboard manufacturers to operate the billboards 15. The digital board player 130 has access to an advertisement library 135, which can choose the appropriate target advertisement 105 based on certain predetermined tags 140. Once the appropriate target advertisement 105 has been selected, the digital board player 130 displays the targeted advertisement 105 on the billboard 15 for a period of time, the period of time being at least as long as the time it takes the vehicle or pedestrian to drive or walk by the billboard 15. This process can then be repeated for other motorists and pedestrians. If the system is not active, or when a targeted advertisement 105 has finished playing, the billboard 15 may display a predetermined generic advertisement for all oncoming traffic. A worker skilled in the art would appreciate that the system may also be able to predict when a vehicle is likely to pass, or when there are more trucks than cars for a certain period of time, based on accumulated video data. Indeed, as the camera is constantly analyzing traffic, patterns can be detected to better serve customers.

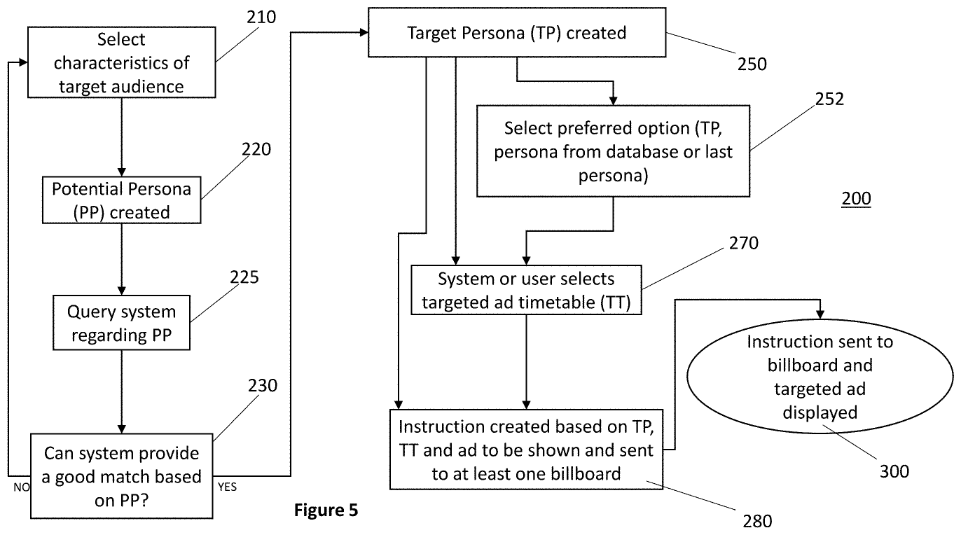

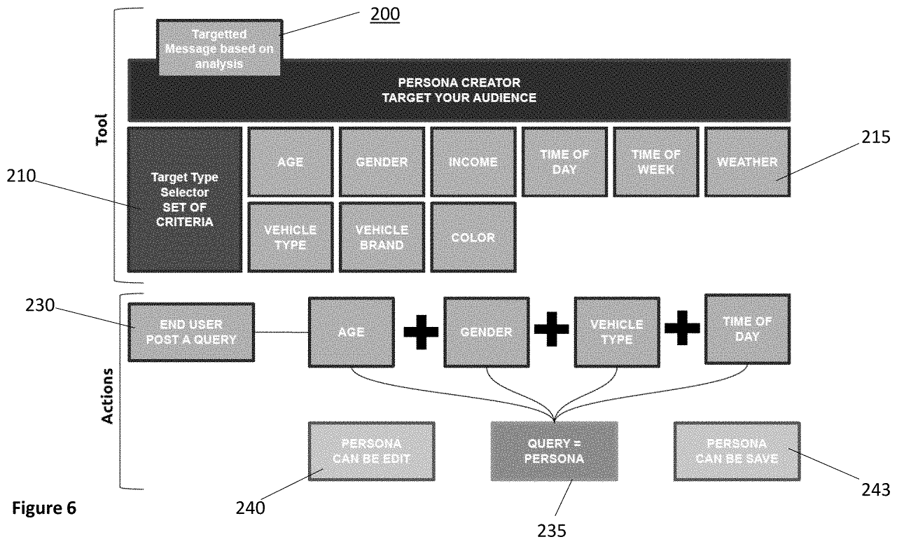

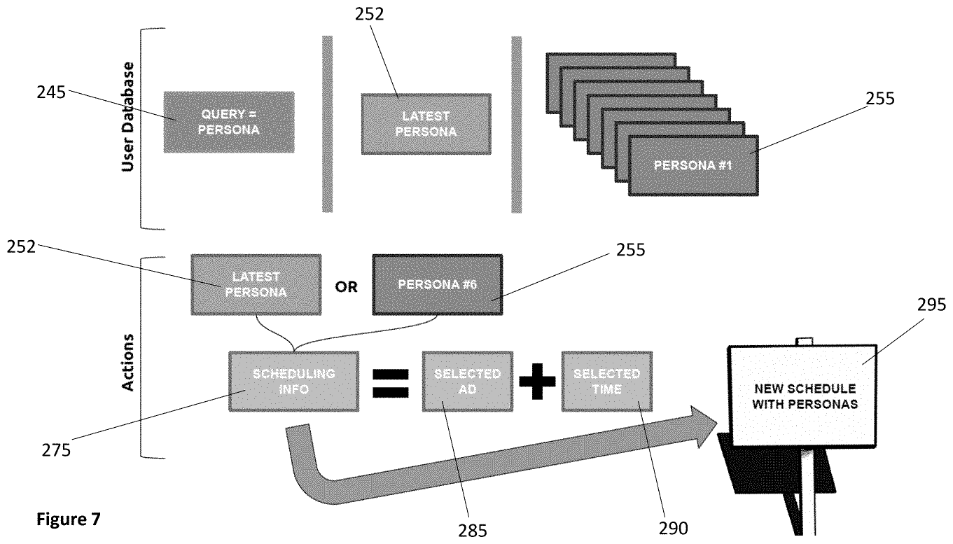

With reference to FIGS. 5, 6 and 7 and according to an embodiment of the present disclosure, a method of generating a targeted advertisement 200 based on user input is shown. The first step 210 is for a user to select preferred characteristics 215 related to the target audience that would view the targeted advertisement 285. The characteristics 215 may include, but are not limited to: age, sex, time of day, weather, vehicle manufacturer, vehicle colour, etc. Once the characteristics 215 are selected, the system creates a potential persona at step 220. A potential persona is based on the chosen characteristics 215. For example, a potential persona may be men in between the ages of 30-50, driving Audi™ trucks. In the third step 225, the system creates a query 230 based on the potential persona. The query 230 is a type of command that the system can read for comparative purposes as outlined in the next step 230. In the fourth step 230, the system compares the query 230 to an internal database. A comparative analysis is undertaken, whereby the system finds the best match of the desired input characteristics having reference to existing characteristics in the database. In some rare instances, the system may not find a good match 240, in which case the system re-sends the query to the first step 210. The user would then have another opportunity to add or subtract characteristics 215 to find a better match. If a good match 243 is found, a target persona 245 is created in step 250. This “target persona” 245 has all or most of the characteristics 215 that were chosen by the user in step 210. In an optional step 252, the system may present the user with the target persona 245, other personas from the database or even with the last persona that had been selected. This is an optional feature of the system whereby the user chooses the target persona 245, another persona whose characteristics have already been chosen and were part of an existing library, or the last searched persona. In another optional step 270, the user may choose a timetable for the targeted advertisement 285 to be viewed (e.g. every Monday between 2-4PM, every second weekend, etc), although this optional step 270 may be embedded in the first step 210 or may be automatically determined by the system. An instruction 275 is created at step 280, the instruction 275 preferably based on the target persona 245, the targeted advertisement 285 to be shown and the desired timetable 290 for the targeted advertisement 285 to run. The instruction 275 is sent to the billboard 295 at step 300.

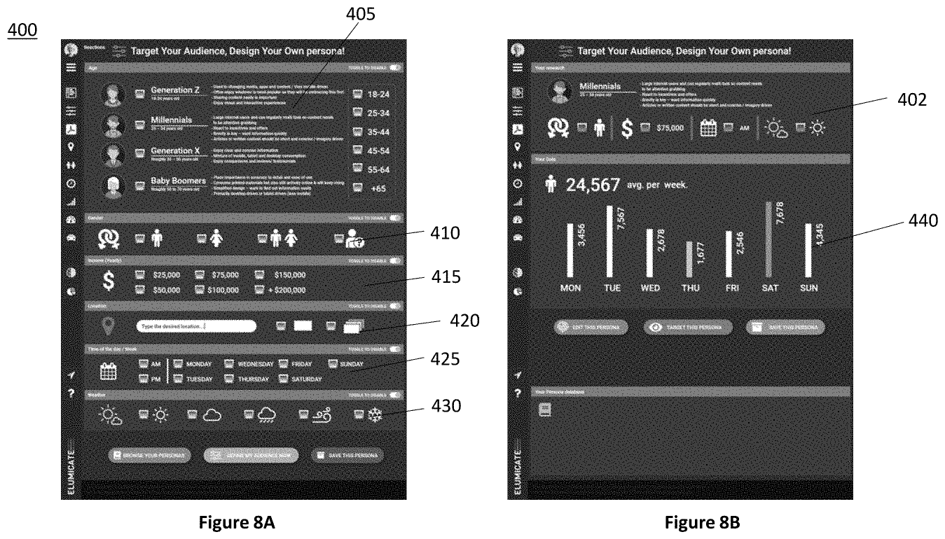

With reference to FIGS. 8A and 8B, a graphical user interface (GUI) 400 is shown for the present system. The GUI 400 is the preferred interface on which a user can interact to select the desired characteristics of the target persona 402. The user is offered options such as age range 405, sex 410, income 415, ad location 420 time of day 425 and weather 430. Based on these characteristics, a target persona 402 is presented in FIG. 8B. A user is also presented with data, which includes number of persons per week 440.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. An apparatus mechanically and electrically secured to a display device to provide targeted advertisements based on real-time video analysis comprising:
a camera unit to record a live video feed;
a processor to process the live video feed and generate a classified data set;
a communication device to transmit the classified data set; and,
at least two circuits electrically connected to the processor and the communication device,
wherein the apparatus is adapted to communicate with remote data centers,
and wherein the communication device sends the classified data set to the display device to display the targeted advertisements.

2. A method of providing targeted advertisements based on real-time video analysis, the steps comprising:
receiving a live video feed;
processing the live video feed to generate a classified data set; and,
sending an instruction based on the classified data set to a display device to display the targeted advertisement.

3. A method of generating targeted advertisements based on chosen characteristics, the steps comprising:
creating a potential persona based on the chosen characteristics;
comparing the potential persona with a database to find a match;
creating a target persona based on the match; and,
sending an instruction to a display device, the instruction containing the target persona,
wherein the instruction instructs the display device to display the targeted advertisements.
